(19) United States
(12) Patent Application Publication
(10) Pub. No.: US 2009/0327270 A1
(43) Pub. Date: Dec. 31, 2009

(54) Using Variation in User Interest to Enhance the Search Experience

(75) Inventors: Jamie B. Teevan, Bellevue, WA (US); Susan T. Dumais, Kirkland, WA (US); Daniel J. Liebling, Seattle, WA (US); Eric J. Horvitz, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/163,561

(22) Filed: Jun. 27, 2008

(51) Int. Cl. G06F 17/30

(52) U.S. Cl. 707/5; 707/E17.014

(57) ABSTRACT

Searches can be enhanced by custom-tailoring results based on a consideration of the variability of the goals of a search given a query. In an example embodiment, a system to enhance searching includes a search interface, a search-goal variability determiner, and a search experience enhancer. The search interface accepts a query from a user as input for a search. The variability determiner determines the variability in user interest (e.g., goals) for the query. The measure of variability in user interest may reflect the degree of variation in the goals of different users or groups of users for the query. The search experience enhancer enhances a search experience for the user responsive to the variability in user interest (e.g., in terms of search goals).

### BACKGROUND

The internet offers a wealth of information that is typically divided into web pages. A web page is a unit of information that is accessible via the internet. Each web page may be available in any one or more of a number of different formats. Example formats include HyperText Markup Language (HTML), Portable Document Format (PDF), and so forth. Each web page may include or otherwise provide access to other types of information in addition to or instead of text. Other types of information include audio, video, interactive content, and so forth.

Web pages include information covering news, hobbies, philosophy, technical matters, entertainment, travel, world cultures, and many other topics. The extent of the information available via the internet provides an opportunity to access many different topics. Different topics can be presented in different languages, different formats (e.g., text, image, video, mixed, etc.), different genres (blogs, newspapers, etc.), and so forth. In fact, the number of web pages and the amount of information that are available over the internet are increasing daily. Unfortunately, the size, scope, and variety of the content offered by the internet can make it difficult to access information that is of particular interest to a user from among the many multitudes of web pages.

### SUMMARY

The search experience can be enhanced by making the results list and/or the overall user experience responsive to the variation of the distribution of interests of different individuals and groups of users. In an example embodiment, a system to enhance searching includes a search interface, a component that determines the variability of search interests (e.g., goals) given queries, and a search experience enhancer. The search interface accepts a query from a user as input for a search. The component determines a variability in user interest (e.g., in the search goals) for the query. The measure of variability in user interest reflects an amount that interests of different users for different search results vary for the query. The search experience enhancer enhances a search experience for the user responsive to the variability in user interest. For instance, the search experience may be enhanced by increasing a degree of personalization that is incorporated into the search as the variability in user interest increases.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Moreover, other systems, methods, devices, media, apparatuses, arrangements, and other example embodiments are described herein.

### BRIEF DESCRIPTION OF THE DRAWINGS

The same numbers are used throughout the drawings to reference like and/or corresponding aspects, features, and components.

FIG. 1 is a block diagram illustrating example search logic that can perform a personalized search and/or a non-personalized search responsive to user interest variability.

FIG. 2A is a flow diagram that illustrates an example of a general method for enhancing searches responsive to user interest variability.

FIG. 2B is a block diagram including an example system that is capable of enhancing searches responsive to user interest variability.

FIG. 3 illustrates an example user interest score matrix regarding one query for multiple users and multiple search results.

FIG. 4 depicts a graph illustrating example potential for personalization curves, which can graphically represent user interest variability.

FIG. 5 is a flow diagram that expands FIG. 2A by illustrating example embodiments for determining the variability in user interest for a query.

FIGS. 6A, 6B, and 6C are block diagrams illustrating example variability measurer embodiments for a variability determiner, which is shown generally at FIG. 2B.

FIG. 7 is a block diagram illustrating an example variability predictor embodiment for a variability determiner, which is shown generally at FIG. 2B.

FIGS. 8A and 8B are block diagrams illustrating an example approach to constructing a potential for personalization curve.

FIG. 9 is a block diagram of an example noise compensator for a variability determiner of FIG. 2B.

FIG. 10 is a flow diagram that expands FIG. 2A by illustrating example embodiments for enhancing a search experience.

FIG. 11 is a block diagram illustrating an example embodiment for a search experience enhancer, which is shown generally at FIG. 2B.

FIG. 12 is a block diagram illustrating an example learning machine embodiment for determining user interest variability.

FIG. 13 is a block diagram illustrating example devices that may be used to implement embodiments for enhancing searches responsive to user interest variability.

### DETAILED DESCRIPTION

### 1: Introduction to Enhancing Searches Responsive to Variability in User Interests and Goals

As explained above, the size, scope, and variety of the content offered by the internet can make it difficult to access information that is of a particular interest to a user from among the many multitudes of web pages. Search engines are available on the internet to aid a user that is trying to find specific information. Search engines crawl the internet and catalog the available information. The cataloged information is usually organized into a search engine index. When a user inputs a query for a search, a ranked listing of web pages that are likely relevant to the query are returned using the search engine index.

A number of factors are pertinent to consider when ranking search results corresponding to web pages. One example is the topical relevance of each document; the topical relevance reflects how closely each document matches the query. Significant research in information retrieval has focused on this issue. However, searching on the internet extends beyond ad hoc retrieval tasks based on straight-forward topical relevance in several ways. For example, while internet content is large and heterogeneous, people's queries are often short and varied. Moreover, their queries may be intended to satisfy different goals, including the navigational goal of accessing a specific target web page, queries in pursuit of information, and queries in pursuit of particular resources. Consequently, there are often many more web page search results that match a query from a topical relevance perspective than a searcher has time to view. The ranking of search results therefore becomes a problem not only of identifying relevant documents, but also of identifying those that are of particular interest to the searcher. Other factors that may be considered when ranking search results include the age of a page, the recency of page access, the genre of content on the page, level of detail, project relevance, and aggregate link information.

For some queries, the results different searchers consider relevant can vary widely. For these queries, the variation in user interest can result in gaps between how well search engines could perform if they were personalized to give users search results tailored to each individual and how well they actually do perform when returning a single search results list that is designed, or at least intended, to satisfy everyone as well as possible. In recognition of the variability in user interest, there has been research on personalized search systems that has focused on developing algorithms to personalize search results using a representation of an individual's interests.

In these conventional personalized search systems, however, the same personalization algorithm is applied to all queries all of the time. Unfortunately, although personalization improves the search results for some queries, it can actually harm the results for other queries. Such harm can occur, for example, when less relevant personal information swamps the effects of topic relevance. Such harm can also occur when less extensive personal information overrides valuable aggregate group information that is based on considerably more data than the personal information alone.

Aggregate group information can be collected in large quantities from other users for queries an individual has never issued before. This aggregate information may be particularly useful when different people's interests for the same query are the same or similar. On the other hand, when there is a lot of information available about what may interest an individual in relation to a particular query, or when a query is relatively vague and/or ambiguous, it can be prudent to focus more or even primarily on the individual during the ranking process of a search operation.

In short, for existing approaches to searching that involve personalization algorithms or query assistance, all queries are treated in the same manner. However, there are significant differences across queries with respect to the benefits that can be achieved through methods such as personalization or query assistance. For some queries, practically everyone who issues the query is looking for the same information. For other queries, different people are interested in very different results even though they may express their interest using the same query terms in the same way.

In contrast with the existing approaches, and as described herein for certain example embodiments, a degree of enhancement that is incorporated into a search operation may be varied responsive to an amount of variability in user interest for a given query. Variability in user interest may be determined using, for example, explicit relevance judgments, implicit relevance judgments (e.g., from large-scale log analysis of user behavior patterns), predictions based on queries and other data, combinations thereof, and so forth. The amount of variability in user interest may be represented by potential for personalization curves or other metrics.

Thus, another factor that can be used for ranking search results is a measure of the amount variation in what different users personally consider relevant to the same query. This measure can be used to determine the amount of personalization applied to a search result list (e.g., a lot if there is a lot of variation, or a little if there is little variation). This measure of variability can also be used to enhance the search experience in other ways, such as by determining which queries to categorize results for, to provide query suggestions for, to provide search help for, or to otherwise assist users in better specifying exactly what they are looking for.

The variability in queries may be predictively characterized using, for example, features of the query itself, features from the search results returned for the query, people's interaction history with the query, and so forth. Using these and other features, predictive models can identify queries for which personalized ranking, query assistance, or some other search experience enhancement is at least partially appropriate and queries for which rich aggregate group data is at least primarily employed instead during the search process (including possibly during a ranking portion).

Generally, enhancing search experiences responsive to user interest variability may entail determining the user interest variability through measurement and/or prediction. As is described further herein below for certain example embodiments, a method includes acts of accepting, determining, enhancing, and presenting. A query is accepted from a user as input for a search. A measure of variability in user interest is determined for the query, with the measure of variability in user interest reflecting an amount that interests of different users for different search results vary for the query. A search experience is enhanced for the user by affecting the search experience in response to the measure of variability in user interest (e.g., by incorporating a degree of personalization into the search responsive to the variability in user interest). A set of search results is presented in accordance with the enhanced search experience.

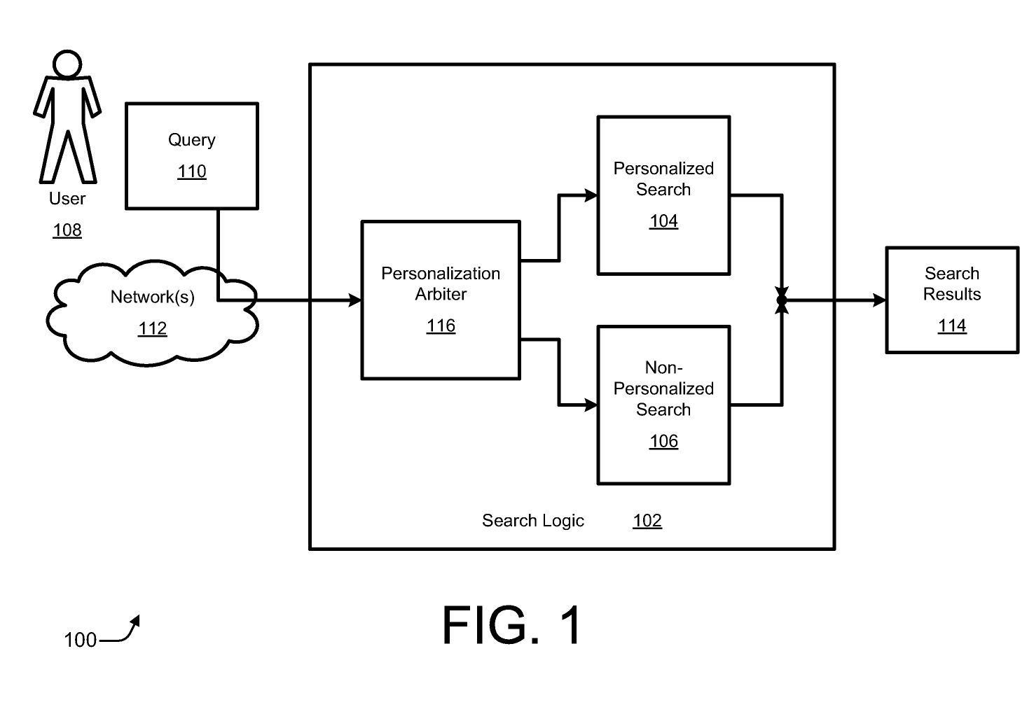

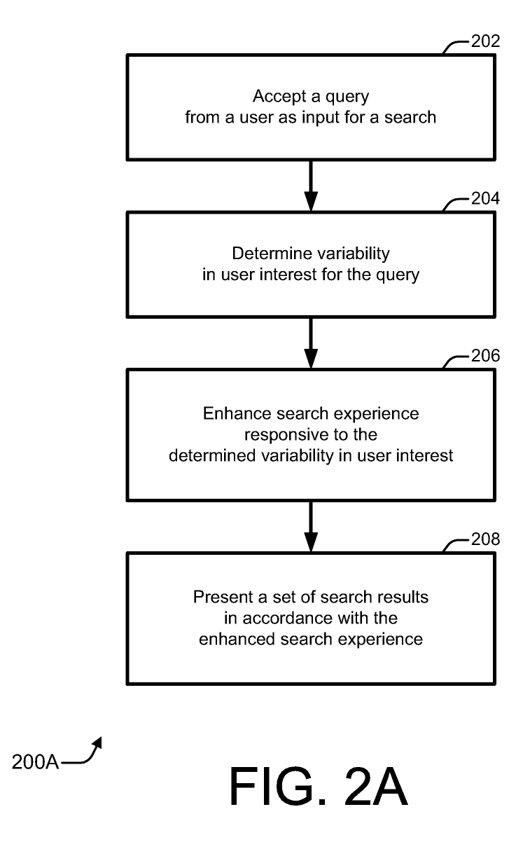

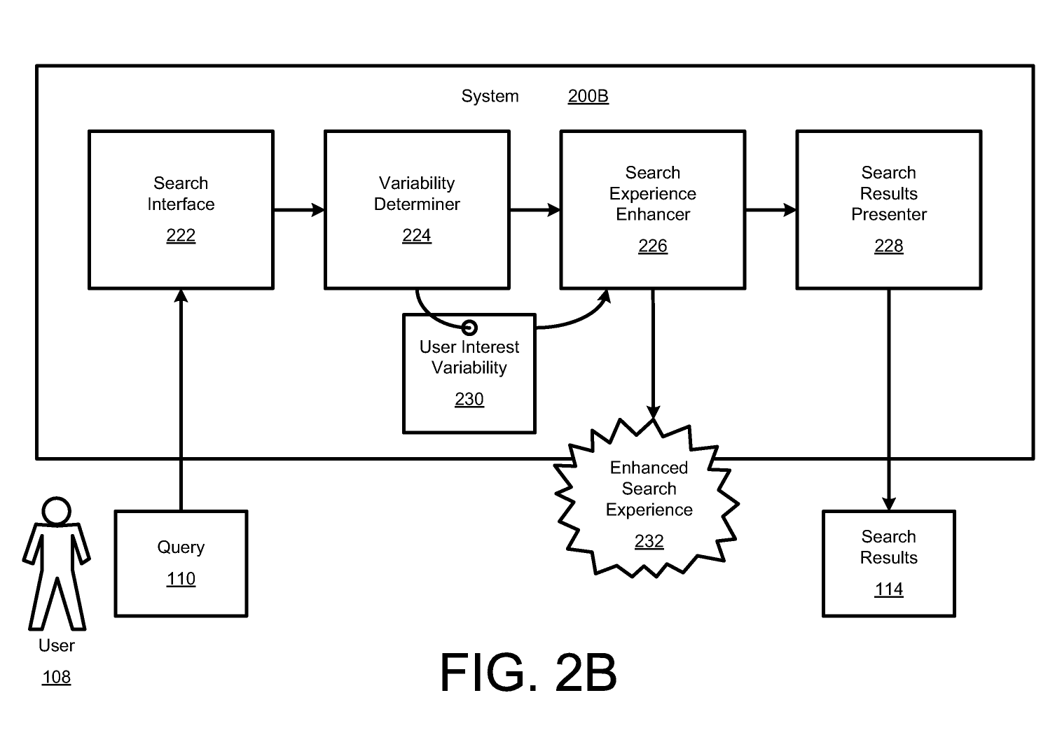

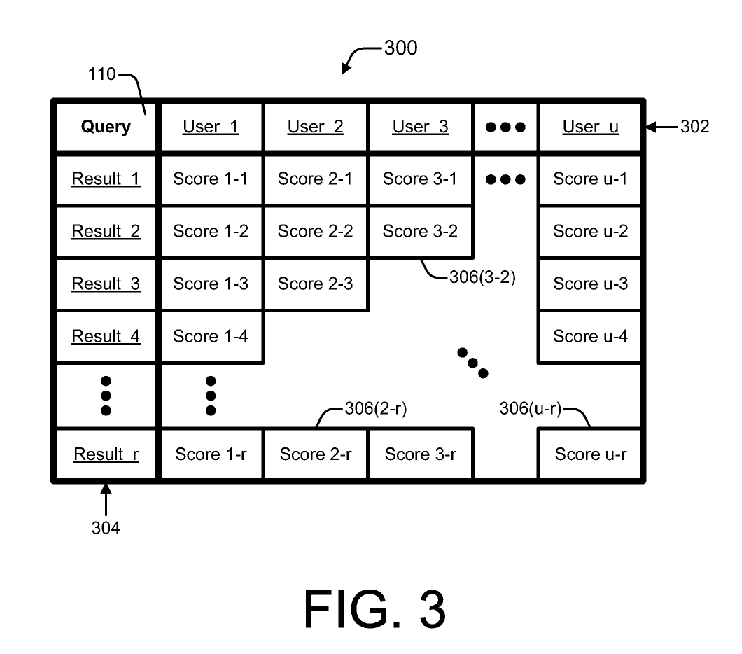

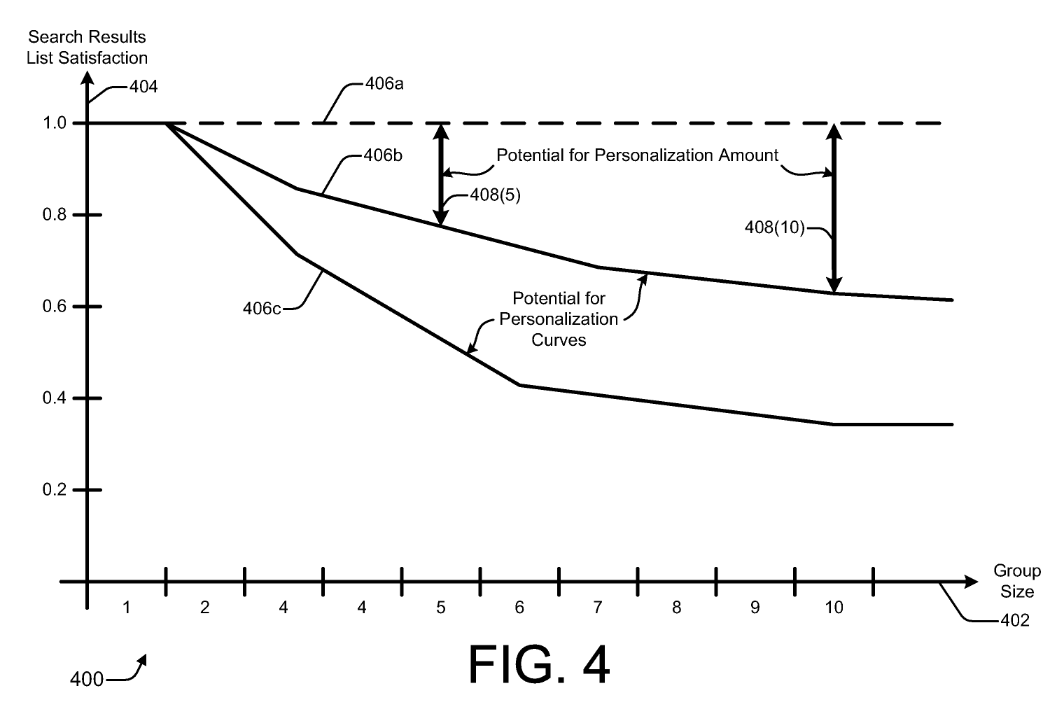

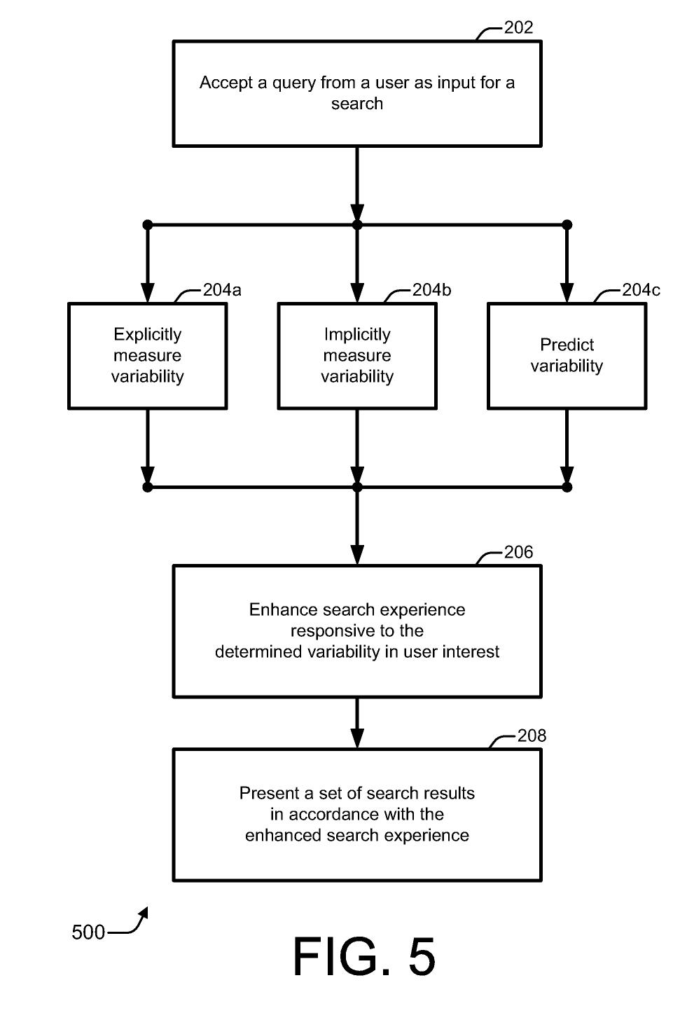

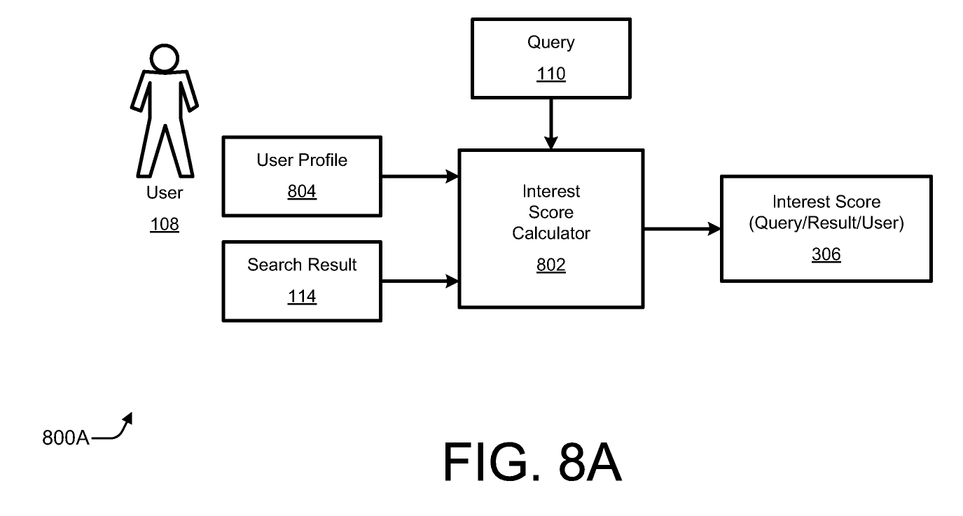

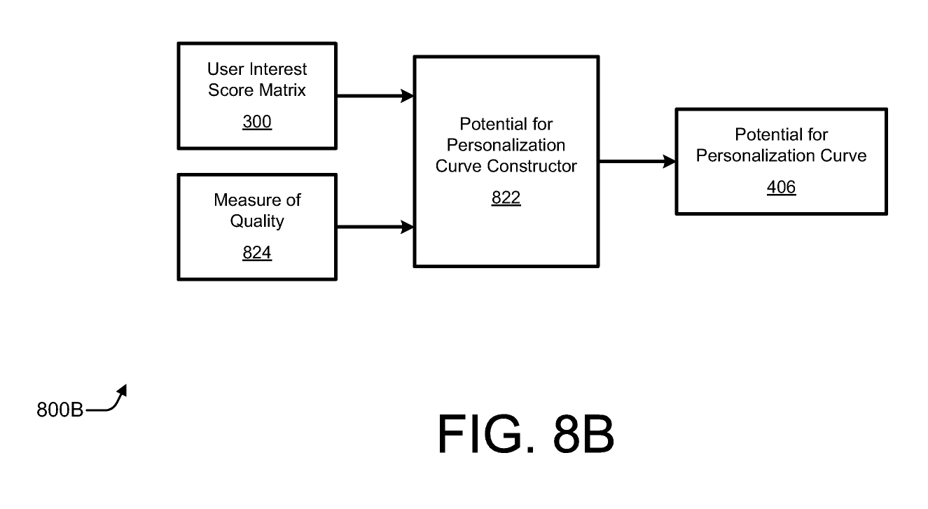

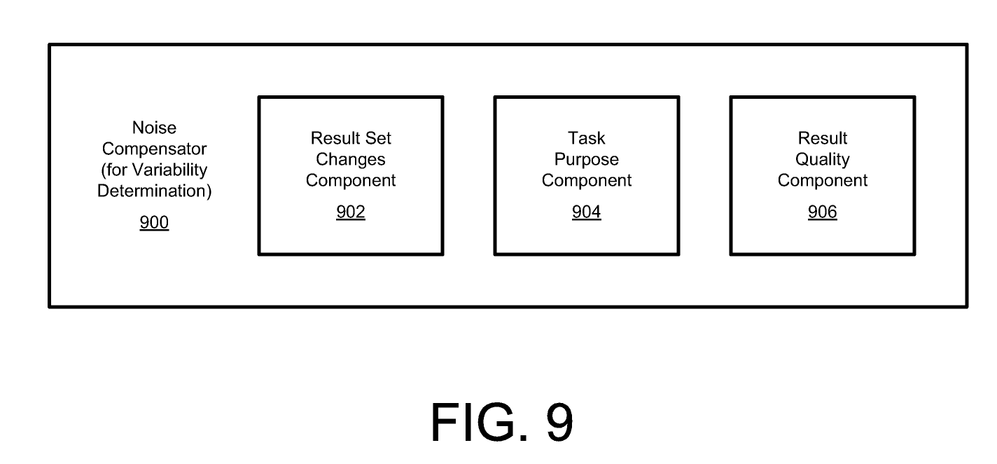

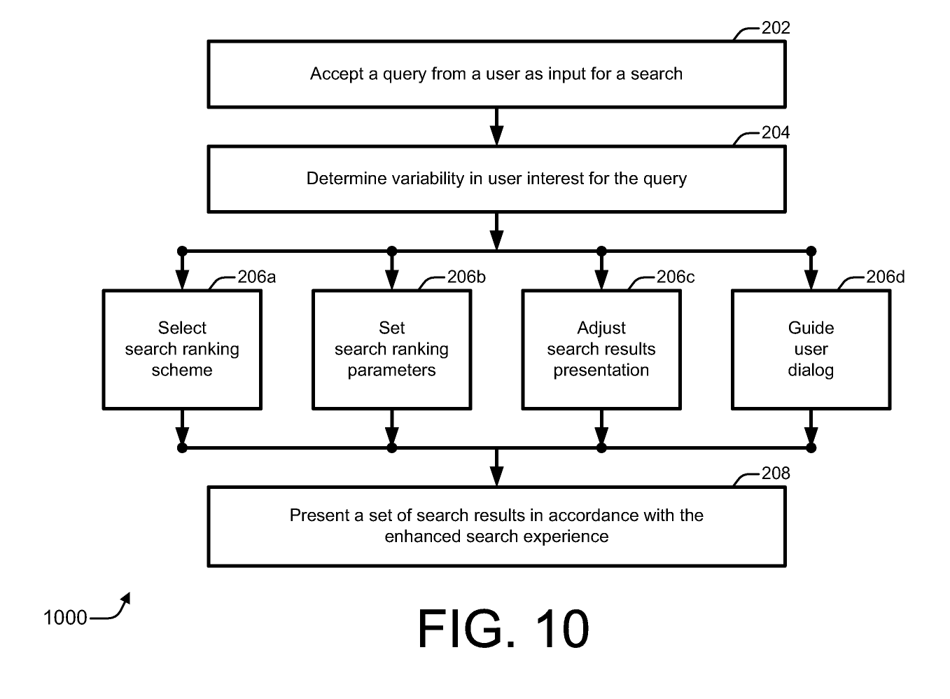

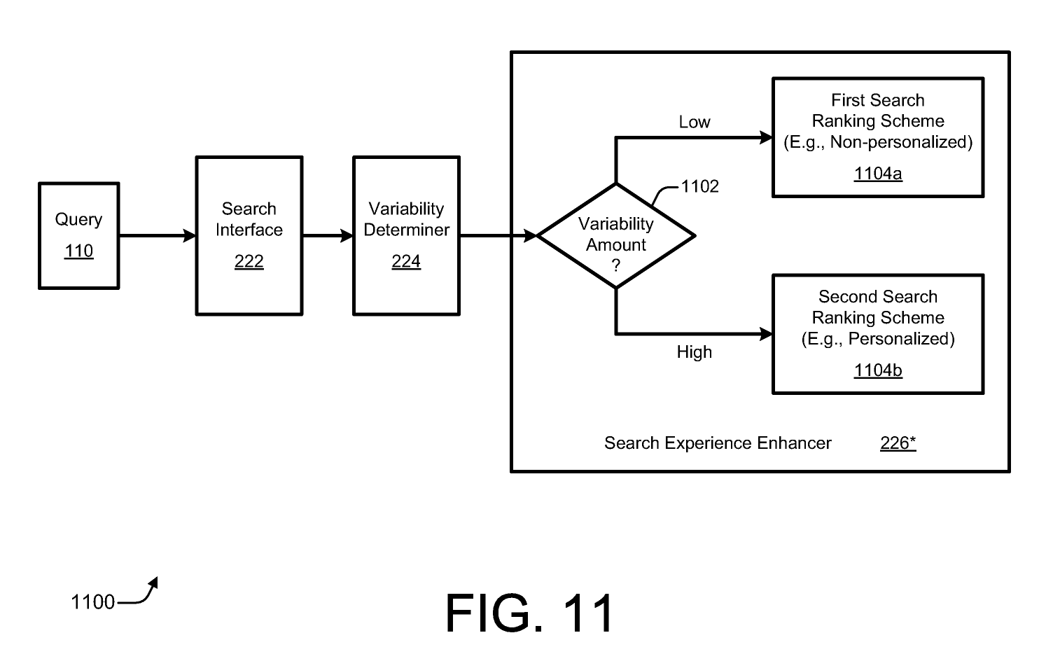

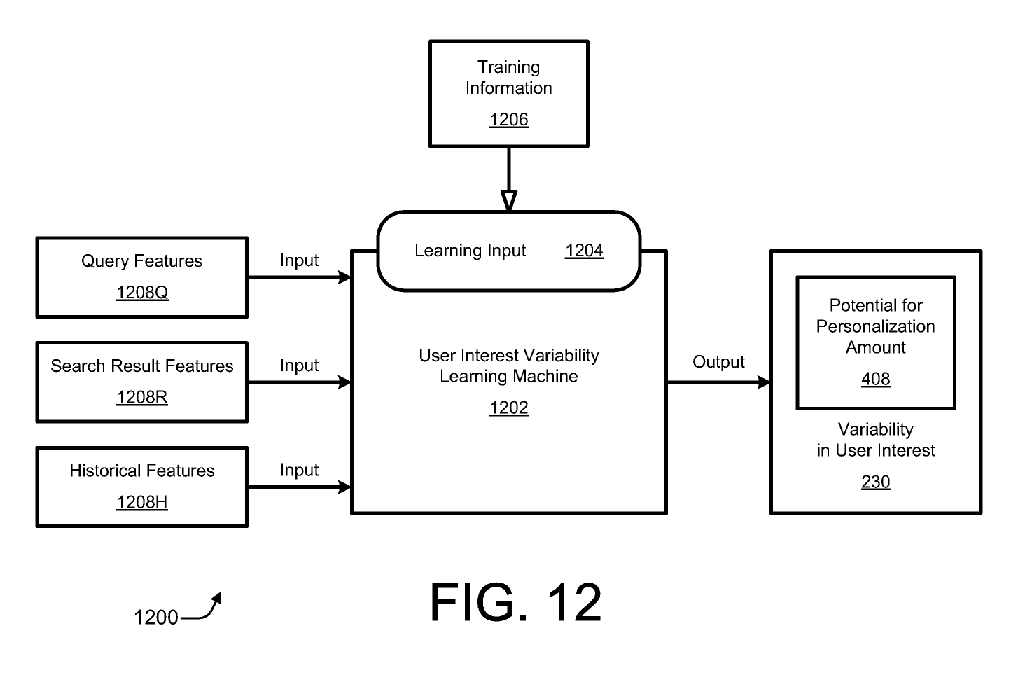

Example general embodiments for enhancing searches responsive to user interest variability are described herein below with particular reference to FIGS. 1, 2A, and 2B. Examples of a user interest score matrix and a potential for personalization curve are described with particular reference to FIGS. 3 and 4, respectively. They may be used to produce and/or understand user interest variability for a given query. FIGS. 5, 6A, 6B, 6C, and 7 are referenced when describing example embodiments for determining user interest variability. An example embodiment for constructing a potential for personalization curve is described with particular reference to FIGS. 8A and 8B. A noise compensator for at least partially controlling noise when determining user interest variability is described with reference to FIG. 9. FIGS. 10 and 11 are referenced to describe example embodiments for enhancing a search experience responsive to user interest variability. An example learning machine embodiment for determining user interest variability is described with particular reference to FIG. 12.

### 2: Example General Embodiments for Enhancing Searches Responsive to User Interest Variability

FIG. 1 is a block diagram 100 illustrating example search logic 102 that can perform a personalized search 104 and/or a non-personalized search 106 responsive to user interest variability. As illustrated, block diagram 100 includes a user 108, a query 110, one or more networks 112, search logic 102, and search results 114. Search logic 102 includes a personalization arbiter 116, personalized search 104, and non-personalized search 106.

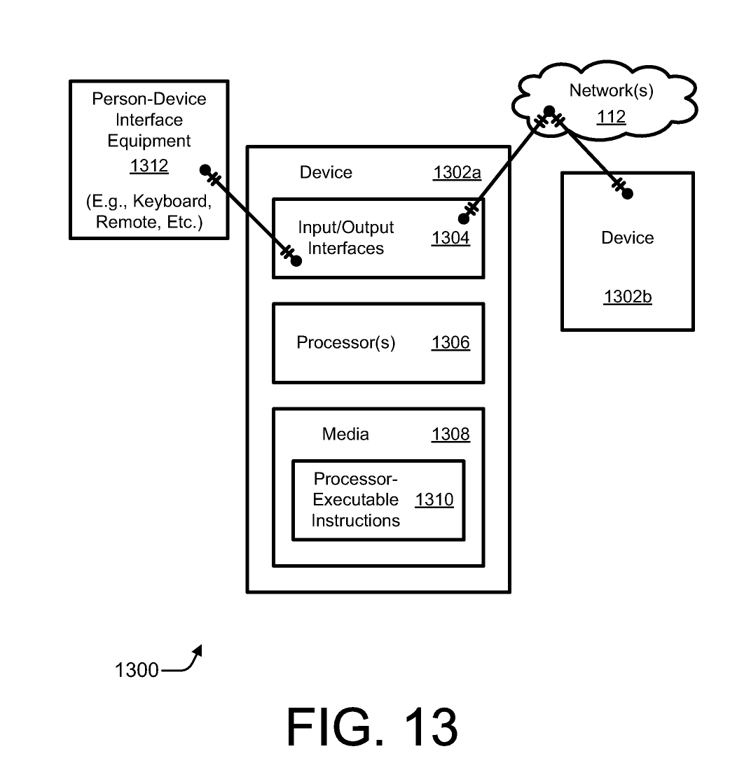

In an example search operation, user 108 formulates search query 110 and submits query 110 to search logic 102. Query 110 is submitted to search logic 102 via one or more networks 112, such as the internet. Search logic 102 performs at least one search for query 110 and produces search results 114. Search results 114 may be returned to user 108 via network 112. Alternatively, search logic 102 may exist and function at a local site where user 108 inputs query 110 directly thereto. Search logic 102 may be embodied as software, firmware, hardware, fixed logic circuitry, some combination thereof, and so forth. Search logic 102 may be realized with one or more processing devices (e.g., of FIG. 13).

It should be noted that a “user” 108 may refer to individual persons and/or to groups of people. The groups may be defined in many different ways (e.g., demographics, locations, interests, etc.). For example, measures of variability may be determined for groups that compare males vs. females, people who live in Washington state vs. New York state, and so forth. Also, although some of the example search logic and/or search experience enhancements described herein pertain to internet searches, the embodiments described herein are not so limited. The searches may also pertain to sets of data/information generally. Examples include, but are not limited to, shopping-related searches, library-related searches, knowledge-base-related searches, institutional-data-related searches, medical-related searches, combinations thereof, and so forth.

In an example embodiment, personalization arbiter 116 is to arbitrate between personalized and non-personalized searches for query 110. For example, personalization arbiter 116 is to determine whether to perform a personalized search 104 based at least in part on query 110. Generally, if the variability in user interest for query 110 is likely to be relatively high, then a personalized search 104 is performed. On the other hand, if the variability in user interest is likely to be relatively low, then a non-personalized search 106 is performed. The result of the search is output as search results 114. Alternatively, personalization arbiter 116 may determine that a combination of personalized search 104 and non-personalized search 106 is to be performed. In such a combination, the degree to which personalized search 104 is incorporated into the overall search operation may be increased as the likelihood of user interest variability increases.

FIG. 2A is a flow diagram 200A that illustrates an example of a general method for enhancing searches responsive to user interest variability. Flow diagram 200A includes four blocks 202-208. Implementations of flow diagram 200A may be realized, for example, as processor-executable instructions and/or as part of search logic 102 (of FIG. 1), including at least partially by a personalization arbiter 116. Example embodiments for implementing flow diagram 200A are described below in conjunction with the description of FIG. 2B.

The acts of the various flow diagrams that are described herein may be performed in many different environments and with a variety of different devices, such as by one or more processing devices (e.g., of FIG. 13). The orders in which the methods are described are not intended to be construed as a limitation, and any number of the described blocks can be combined, augmented, rearranged, and/or omitted to implement a respective method, or an alternative method that is equivalent thereto. Although specific elements of certain other FIGS. are referenced in the description of the flow diagrams, the methods may be performed with alternative elements.

FIG. 2B is a block diagram including an example system 200B that is capable of enhancing searches responsive to user interest variability 230. As illustrated, system 200B includes search interface 222, variability determiner 224, search experience enhancer 226, and search results presenter 228. System 200B accepts as input a query 110 that is from a user 108 or that is automatically generated (e.g., from a currently-viewed web page). System 200B produces, at least partially, an enhanced search experience 232 responsive to user interest variability 230. System 200B may also output search results 114. An implementation of search logic 102 (of FIG. 1) may comprise, for example, system 200B.

Flow diagram 200A of FIG. 2A and system 200B of FIG. 2B are jointly described. In example embodiments, at block 202, a query is accepted from a user as input for a search. For example, search interface 222 may accept query 110 from user 108 as input for a search. Search interface 222 may present to user 108 a dialog box, a web page or browser form field, a pop-up entry field, some combination thereof, etc. to enable user 108 to input query 110. For a textual search, query 110 may be a set of alphanumeric or other language characters forming one or more words, or parts thereof.

At block 204, a variability in user interest (e.g., a measure of variability in user interest) for the query is determined. For example, variability determiner 224 may determine a likely variability in interest for the inputting user 108 and/or users 108 in general. User interest variability 230 reflects an amount that respective interests of different users for respective search results 114 may vary for the same input query 110. In other words, the variability in user interest reflects an amount that interests of different users for different search results vary (including are likely to vary) for the input query.

By way of example, navigational queries typically have relatively low user interest variability. In other words, for an input query such as “companyname.com” or a similar input query 110, most users are interested in the same search result (or results). On the other hand, different users may be interested in different search results for an input query such as “Washington” input query 110. For instance, some users may be interested in search results pertaining to the State of Washington while others may be interested in those pertaining to Washington, D.C. Moreover, still others may be interested in search results pertaining to George Washington the president, a sports team whose home is in Washington, a university located in Washington, and so forth. Thus, for this “Washington” query, there may be relatively high user interest variability.

User interest variability 230 may therefore reflect an extent to which different individual users have or are likely to have different interests in a set of search results that are produced for the same query. User interest variability 230 may also be considered a representation of query ambiguity. This user interest variability 230 may be determined, for example, by measuring it and/or by predicting it. Example embodiments for determining user interest variability are described herein below with particular reference to FIGS. 5, 6A-6C, and 7.

At block 206, a search experience is enhanced responsive to the determined variability in user interest. For example, responsive to user interest variability 230 as determined by variability determiner 224, search experience enhancer 226 may enhance a search experience 232 for user 108. Such enhancements may include, for instance, setting a degree to which a search operation incorporates a personalization component, adjusting a search results presentation, some combination thereof, and so forth.

Additional ways of enhancing a search experience in response to a measure of variability in user interest include, but are not limited to: clustering results when the variability is higher (e.g., also determining cluster size as a function of variability), providing query formulation assistance when variability is higher (e.g., query suggestions of less variable queries, facets for refining the query to be more specific, tutorials for people who issue highly variable queries, etc.), altering the ranking algorithm based on—in addition to or instead of on personalization—a function of variability (e.g., by encouraging general result set diversity for queries with high variability and consistency for queries with low variability), by devoting ranking resources differently to queries with different variability (e.g., expending more resources for queries with a lot of variability), combinations thereof, and so forth. Example embodiments for enhancing a search experience are described further herein below with particular references to FIGS. 10 and 11.

At block 208, a set of search results is presented in accordance with the enhanced search experience. For example, search results presenter 228 may present search results 114 to user 108. Presentation may include transmitting and/or displaying search results 114 to user 108.

Thus, for an example embodiment of system 200B, search interface 222 is to accept a query 110 from a user 108 as input for a search. Variability determiner 224 is to determine a measure of user interest variability 230 for query 110, with the measure of user interest variability 230 reflecting an amount that interests of different users for different search results vary for query 110. A search experience enhancer 226 is to enhance a search experience 232 for user 108 responsive to user interest variability 230. Additionally, search results presenter 228 of system 200B is to present search results 114 that are produced from enhanced search experience 232 to user 108.

### 3: Example Specific Embodiments for Enhancing Searches Responsive to User Interest Variability

FIG. 3 illustrates an example user interest score matrix 300 regarding one query for multiple users and multiple search results. As illustrated, user interest score matrix 300 corresponds to a query 110. A user row 302 includes “u” users 1, 2, 3 . . . u, with “u” representing some integer. A search results column 304 includes “r” search results 1, 2, 3, 4 . . . r, with “r” representing some integer. Alternatively, each row may correspond to a user with each column corresponding to a search result. At the intersection of any given user “x” and particular search result “y”, an interest score 306(x-y) is included in user interest score matrix 300. Three interest scores 306 are explicitly indicated in FIG. 3: interest score 306(2-r), interest score 306(3-2), and interest score (u-r).

In an example embodiment, user interest score matrix 300 includes respective interest scores 306 that correspond to respective interest levels of users for particular search results. Each entry of user row 302 and hence each column of user interest score matrix 300 is associated with a user, such as user 108 (of FIGS. 1 and 2B). Each entry of search results column 304 and hence each row of user interest score matrix 300 is associated with a particular search result, such as one of search results 114 (also of FIGS. 1 and 2B). For example, interest score 306(3-2) corresponds to an interest level that User 3 has for Result 2. Interest score 306(2-r) corresponds to an interest level that User 2 has for Result r. Interest scores may be realized in any manner using any scale, and they may be normalized (e.g., from 0.0 to 1.0 with 1.0 representing relatively strong interest).

By way of example, for the column of User 2, Score 2-1 may be 0.8, Score 2-2 may be 0.4, Score 2-3 may be unknown . . . Score 2-r may be 0.9. Because Score 2-r is relatively high, User 2 has a relatively strong interest in Result r when submitting query 110. Because Score 2-2 is relatively low, User 2 has a relatively weak interest in Result 2 when submitting query 110. In contrast, Score 3-r may be 0.3 while Score 3-2 may be 0.8. User 3 would therefore have a relatively weak interest in Result r but a relatively strong interest in Result 2. Thus, given a query 110, the respective interest levels as represented by interest scores 306 of each user for respective results may be added to user interest score matrix 300. In other words, when taken as a group, interest scores 306 are an example of indications of the variability in the interest levels of different users with respect to multiple search results.

Interest scores 306 may constitute or may be derived from explicit, implicit, and/or predicted interest indications. In other words, interest scores 306 of user interest score matrix 300 may be gathered from a number of different sources. Example sources of interest scores are as follows. They may be explicitly measured through surveys of users. They may be implicitly measured by observing user behavior and/or by making content comparisons. They may also be predicted from query features, features of search results sets, features derived from historical search information, combinations thereof, and so forth. After gathering interest scores 306, user interest score matrix 300 may be built.

A set of search results 114 (from FIGS. 1 and 2B) can be optimally ranked for an individual user in accordance with the interest scores 306 for that user. However, except when two users have identically-ordered interest scores 306, the optimal ranking for one user will not be optimal for another user. Consequently, if a single search result ranking for query 110 is prepared for two different users, one or both of the two users will be presented a compromise search result listing that is sub-optimal with regard to their individual respective interest scores. As more users submit the same query 110, the amount of compromise involved in preparing a single search result listing for each of them tends to grow. Thus, the differences between a respective optimal search result ranking for each respective user and a compromise ranking for the group of users tend to grow as the size of the group grows. The concept of this divergence between an optimal listing and a compromise listing is shown graphically with a potential for personalization curve, which is described below with particular reference to FIG. 4.

FIG. 4 depicts a graph 400 that illustrates example potential for personalization curves 406, which can graphically represent user interest variability at different group sizes. As shown, graph 400 includes an abscissa axis (x-axis) that represents group size 402 and an ordinate axis (y-axis) that represents search results list satisfaction 404. Graph 400 includes three potential for personalization curves 406a, 406b, and 406c and two indicated potential for personalization amounts 408. Group size 402 starts at one and extends to 10, but a total group size may be any number of users. Search results list satisfaction 404 is normalized and scaled from 0.0 to 1.0; however, other normalized or non-normalized scalings may be used.

With a group size 402 of one, the search result listing can agree perfectly with the user's interest (assuming accurate interest score information). As the size of the group grows, there can still be an optimal search result listing order or ranking when user interest variability is very low, if not approaching zero. This case is illustrated in the flat potential for personalization curve 406a. However, there is frequently some user interest variability, and thus a potential for personalization curve dips below the level of the flat potential for personalization curve 406a. Two other example potential for personalization curves 406b and 406c are shown.

Potential for personalization curves 406b and 406c deviate from the “optimal” search results list satisfaction level an increasing amount as the group size increases. Typically, these curves begin to eventually level off with larger group sizes as user interest scores between and among different users begin to coincide and/or overlap on average. The distance between each potential for personalization curve 406b and 406c and the maximum search results list satisfaction level possessed by the flat potential for personalization curve 406a is termed herein a potential for personalization amount 408.

Two specific potential for personalization amounts 408 for potential for personalization curve 406b are shown. These are potential for personalization amounts 408(5) and 408(10). Potential for personalization amount 408(5) corresponds to the potential for personalization amount 408 at a group size of five, and potential for personalization amount 408(10) corresponds to the potential for personalization amount 408 at a group size of ten. Generally, a potential for personalization amount 408 represents the amount a search result listing can potentially be improved for an individual user and/or particular query through a personalized search as compared to a compromise search result listing for a group that is from a non-personalized search.

A potential for personalization curve 406 is an example of a user interest variability metric. A potential for personalization amount 408 is derivable from a potential for personalization curve 406 and is also a user interest variability metric. Inversely, multiple potential for personalization amounts 408 may be used to derive a potential for personalization curve 406. Other examples of user interest variability metrics are described herein below, especially with reference to FIGS. 5, 6A-6C, and 7.

For graph 400, search results list satisfaction 404 may be expressed in any units or manner. For example, it may be determined in the context of, and denominated in units of, normalized Discounted Cumulative Gain (nDCG), precision at N, or some other measure of the quality of the set of search results. The information of a potential for personalization curve 406 may be summarized in different ways. For example, it may be summarized using the search results list satisfaction of the potential for personalization gap at group sizes of 5 and 10, which may be referred to as the Potential at 5 and the Potential at 10, respectively.

In other words, with graph 400 different group sizes 402 are shown on the x-axis, while the y-axis represents how well a single search result listing can satisfy each group member in a group of a given size. For a group size of one, the optimal ranking is one that returns the search results that the individual considers more relevant closer to the top of the listing. Such a hypothetical search result listing satisfies the single group member perfectly, and thus the search results list satisfaction value of each potential for personalization curve 406 at a group size of one is 1.0 (using nDCG and assuming accurate interest score information).

For a group size of two, an optimal listing may rank the search results that both members consider relevant first (to the extent possible), followed by the results that only one user considers relevant (or highly relevant). A single listing can no longer satisfy both members perfectly (unless they happen to have identical rankings), so the average search results list satisfaction drops for the group members overall. As the group size grows, so does the gap between the optimal performance attainable for each individual user and the optimized compromise performance for the group overall.

However, the size of this gap—the potential for personalization amount 408—is not constant. For example, the gap size depends on the query. When each group member does have the same relevance judgments for a set of results for a given query, then the same results listing can make everyone maximally happy, regardless of group size. The curve in such cases is flat at a normalized DCG of 1, as can be seen for potential for personalization curve 406a. As different people's notions of relevance for the same search results for the same query vary, the gap between what is an ideal compromise for the group and what is ideal for an individual grows, as can be seen for potential for personalization curves 406b and 406c. Hence, queries having larger gaps, or potential for personalization amounts 408, are more likely to benefit from incorporating personalization into a search operation.

FIG. 5 is a flow diagram 500 that expands FIG. 2A by illustrating example embodiments for determining the variability in user interest for a query. As illustrated, flow diagram 500 includes six blocks 202, 204a, 204b, 204c, 206, and 208. The acts of blocks 202, 206, and 208 are described herein above with particular reference to flow diagram 200A of FIG. 2A. Block 204 of flow diagram 200A entails determining the variability in user interest for a query. Blocks 204a, 204b, and 204c of flow diagram 500 provide example embodiments for implementing the act(s) of block 204.

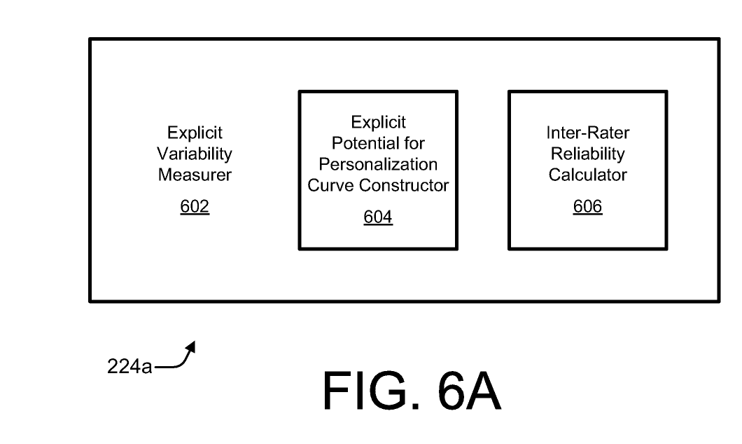

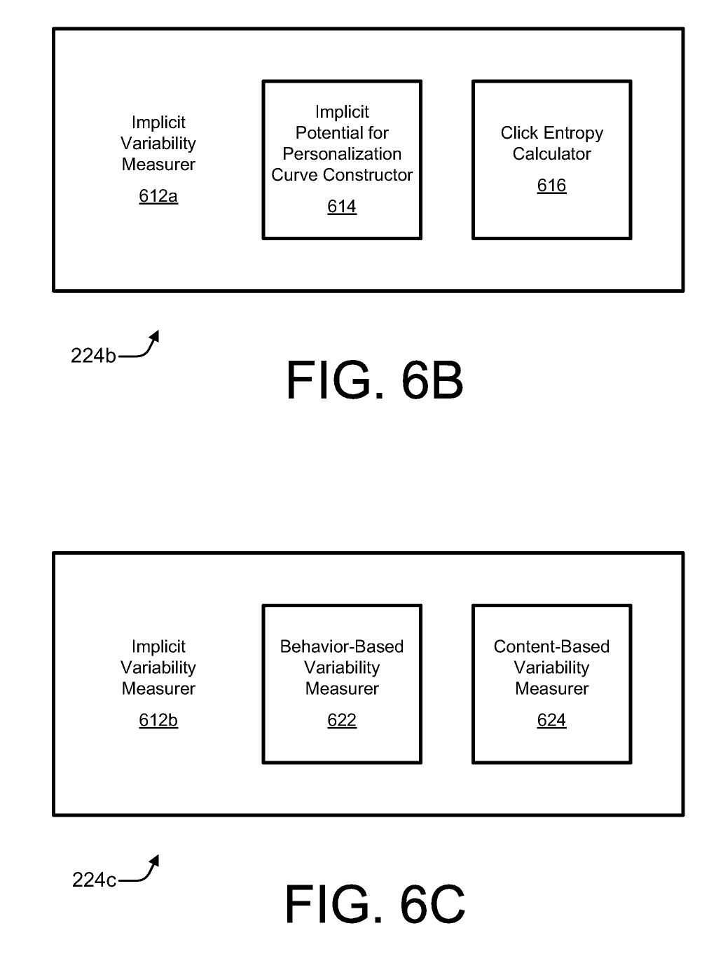

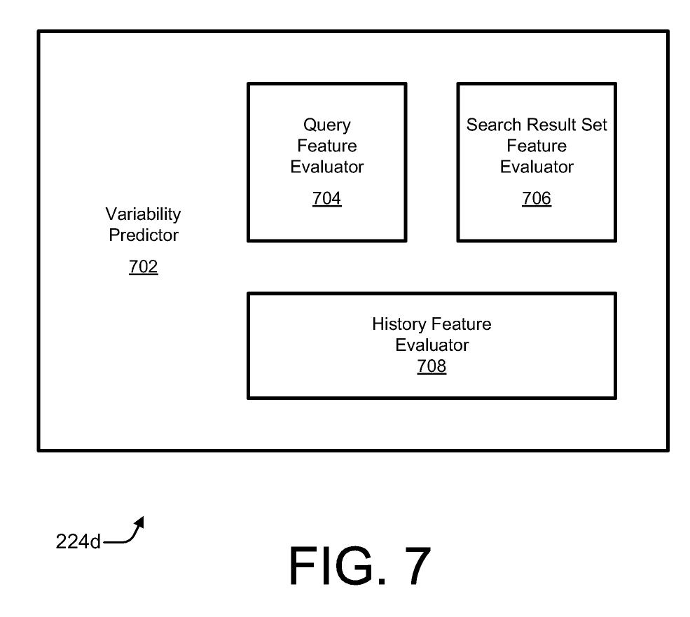

At block 204a, user interest variability is measured explicitly. Examples of explicit measurements are described below with particular reference to FIG. 6A. At block 204b, user interest variability is measured implicitly. Examples of implicit measurements are described below with particular reference to FIGS. 6B and 6C. At block 204c, user interest variability is predicted based, at least in part, on the input query. Examples of variability predictions are described below with particular reference to FIG. 7. It should be noted that an implementation of variability determiner 224 (of FIG. 2B) may separately or jointly include any of the aspects described with respect to the embodiments of FIGS. 6A-6C and 7.

FIGS. 6A, 6B, and 6C are block diagrams illustrating example variability measurer embodiments for a variability determiner 224, which is shown generally at FIG. 2B. System 200B (of FIG. 2B) includes variability determiner 224. Variability determiner 224a of FIG. 6A comprises an explicit variability measurer 602. Variability determiners 224b and 224c of FIGS. 6B and 6C, respectively, comprise implicit variability measurers 612a and 612b. Each of these variability measurer embodiments of variability determiner 224 is described below.

With reference to FIG. 6A, explicit variability measurer 602 is to explicitly measure user interest variability in one or more manners. Two example implementations for explicit variability measurer 602 are illustrated: an explicit potential for personalization curve constructor 604 and an inter-rater reliability calculator 606. Explicit potential for personalization curve constructor 604 is to use explicit indications of user interest to construct at least part of a potential for personalization curve 406 (of FIG. 4). For instance, a survey of users who have submitted a given query can be used to collect explicit interest scores 306 for a user interest score matrix 300 (both of FIG. 3). The survey may be conducted manually or electronically. It may be disseminated in bulk, may be proffered to the user at the time a query is submitted, and so forth.

An explicit inter-rater reliability calculator 606 also uses explicit indications of user interest. Inter-rater reliability calculator 606 is to calculate the inter-rater reliability between users to measure how much the explicit relevance judgments differ between users. (However, it may also be used to calculate any of the values, explicit or implicit, in the user interest score matrix described above.) By way of example, inter-rater reliability may be calculated using Fleiss's Kappa (κ) for those queries for which explicit user interest levels have been collected. (Kappa may also be applied in the context of implicit measures.) Fleiss's Kappa (κ) measures the extent to which the observed probability of agreement (P) exceeds the expected probability of agreement (Pₑ) if all raters were to make their ratings randomly. It is determinable by the following equation:

κ=(P−Pₑ)/(1−Pₑ).

As described with respect to explicit variability measurer 602, the calculation of inter-rater reliability and the construction of (explicit) potential for personalization curves both involve using explicit relevance judgments. Because explicit relevance judgments can be expensive to acquire, implicit indications of query ambiguity that rely on implicit data may be used instead. These implicit indications use other information as a proxy for explicit indications of relevance. For example, clicks may be used to capture the variation in search results of which users are interested. An underlying assumption is that queries for which there is great variation in the search results that are clicked also have great variation in what users consider relevant.

With reference to FIG. 6B, variability determiner 224b is embodied as implicit variability measurer 612a. Implicit variability measurer 612a is to implicitly measure user interest variability, or query ambiguity, in one or more manners. Two example implementations of implicit variability measurer 612a are illustrated: an implicit potential for personalization curve constructor 614 and a click entropy calculator 616. Implicit potential for personalization curve constructor 614 is to use implicit indications of user interest to construct at least part of a potential for personalization curve 406. For instance, those listed search results that are clicked by users may be considered an approximation for explicitly-indicated relevancies. In other words, a user's click on a search result can be considered an implicit indication of user interest in each search result that is clicked. When search results list satisfaction 404 (of FIG. 4) is determined in the context of nDCG units, each clicked search result may be given a gain of one.

Click entropy calculator 616 is to measure user interest variability based on click entropy. Click entropy probabilistically reflects the variety of different search results that are clicked on in a set of search results for a given query. Click entropy may be calculated in accordance with the following equation:

$$Click entropy ( q ) = - {\sum }_{URLu} p ( {c}_{u} \vert q ) * {log}_{2} ( p ( {c}_{u} \vert q ) ) ,$$

where p(cᵤ|q) is the probability that a uniform resource locator (URL) u was clicked following query q. Thus, in an example implementation, click entropy calculator 616 is to calculate the click entropy for the query based on a probability that individual search results are clicked when the query is submitted.

With reference to FIG. 6C, variability determiner 224c is embodied as implicit variability measurer 612b. Implicit variability measurer 612b is to implicitly measure user interest variability in one or more manners. Two example implementations are illustrated: a behavior-based variability measurer 622 and a content-based variability measurer 624.

Behavior-based variability measurer 622 is to measure user interest variability based on user behavior. More specifically, behavior-based variability measurer 622 is to measure user interest variability based on observable user interaction behaviors with a search results listing that is produced for a query. Example user interaction behaviors include click data, dwell time, frequency of clicks, combinations thereof, and so forth. Click data may include which search results are clicked on. Hence, behavior-based variability measurer 622 may operate in conjunction with implicit potential for personalization curve constructor 614 and/or click entropy calculator 616. In fact, click entropy may be considered an example of a behavior-based measure.

Dwell time refers to the amount of time that elapses while a user reviews a set of search results and/or the amount of time a user spends at the web page of each search result that is clicked on. Frequency of clicks refers to the percentage of users that click on particular search results for a given query. These behavior-based user interactions may be monitored locally or remotely with general web software (e.g., a web browser, a web search engine, etc.) or specialized software (e.g., a proxy, a plug-in, etc.). Other behavior-based user interactions may also be monitored and applied by behavior-based variability measurer 622.

Content-based variability measurer 624 is to measure user interest variability based on content. For example, each search result may be compared to a user profile to ascertain the similarity between a particular search result and the user profile. The user profile may include recorded behaviors, cached web content, previous web searches, material stored locally, explicit indications of interest, and so forth. The similarity may be ascertained using any similarity metric, such as a cosine similarity metric.

For the similarity comparison between the user profile and the search results by content-based variability measurer 624, each search result may be represented in any one or more of a number of different forms. Example forms include a term vector, a probabilistic model, a topic class vector, combinations thereof, and so forth. With a term vector, the search result can be represented with a snippet (e.g., with the title), with anchor text proximate to keywords, with the full text of the web page, a combination thereof, and so forth.

Because many queries that are submitted to a search engine are unique, explicit measures of user interest variability or implicit measures of user interest variability that involve a history with a submitted query may not be available. Determining whether a query is appropriate for enhancement (e.g., via personalization) may therefore entail predictions of user interest variability. Example embodiments in which metrics of query ambiguity can be predicted are also described herein. Such predictions can use one or more direct or indirect features of the query. In other words, some of these features are directly derivable from the query, such as the query string. Other features are indirectly derivable from the query. These indirectly derivable features involve additional information about the query, such as the result set. Other features can also involve some history information about the query for use in predictive determinations of user interest variability. Example predictive embodiments for determining user interest variability are described below with particular reference to FIG. 7.

FIG. 7 is a block diagram illustrating an example variability predictor embodiment for a variability determiner 224, which is shown generally at FIG. 2B. Variability determiner 224d comprises a variability predictor 702. As illustrated, variability predictor 702 includes a query feature evaluator 704, a search result set feature evaluator 706, and a history feature evaluator 708.

In an example embodiment, variability predictor 702 is to predict user interest variability for a query. The prediction may be based on features directly derivable from the query and/or on features that are indirectly derivable from the query. Query feature evaluator 704 is to evaluate features that are directly derivable from the query. Search result set feature evaluator 706 is to evaluate features that are indirectly derivable from the query by way of the search result set. History feature evaluator 708 is to evaluate features of the query that are collected from previous submissions of the query. The historical features may be related to query features and/or to search result set features.

Examples of some of the various features that may be involved in user interest variability prediction are provided below in Table 1. These features are organized by the type of information used to calculate the feature (e.g., query or search result set information) and the amount of query history used to calculate the feature (e.g., no history or some history). Table 1 is therefore a 2×2 grid that includes query and search result set features for the row headings and the absence or presence of historical features for the column headings. The lower-left quadrant includes Open Directory Project (ODP)-related features.

TABLE 1
Features for predicting user interest variability.

| | Without Historical Features | With Historical Features |
|---|---|---|
| Query | Query length (chars, words) | Reformulation probability |
| Features | Contains location | # of times query issued |
| | Contains URL fragment | # of users who issued query |
| | Contains advanced operator(s) | Avg/σ time of day issued |
| | Time of day issued | Avg/σ issued during work |
| | Issued during work hours | Avg/σ document frequency |
| | Document frequency | Avg/σ # of query suggestions |
| | # of query suggestions offered | Avg/σ # of ads |
| | # of ads (mainline and sidebar) | |
| | Has a definitive result | |
| Search | Query clarity | Result entropy |
| Result | ODP category entropy | Click entropy |
| Set | # of ODP categories | Avg/σ rank of click |
| Features | # of distinct ODP categories | Avg/σ time to click |
| | # of URLs matching ODP | Avg/σ clicks per user |
| | Portion of results non-html | Potential for personalization |
| | Portion that are “.com”/“.edu” | curve (cluster, Δ5, Δ10) |
| | # of distinct domains | |

The values for features involving averages (Avg) and variances (σ) may be calculated for each of the instances in which a query has been previously submitted. There are usually differences in the search results returned for the same query over time, differences in the interactions by users with the search results, and differences in the time of day when the query is or was issued.

Query feature evaluator 704 is to evaluate at least one feature of the query to predict the variability in user interest based on the at least one feature. There are a number of features that can be evaluated based on the issuance of a query without historical information. Some examples are listed in the upper left-hand quadrant of Table 1. These features include, for instance: the query length and whether the query uses advanced syntax, mentions a geographic location, or contains a URL fragment. Moreover, other query-based features that are not listed above may be used. For example, external resources such as dictionaries, thesauri or others may be consulted to determine query characteristics such as the number of meanings a query has, which may also be used as input features.

In addition to features that relate to the query string itself, there are other features that relate to one instance of a query submission, such as temporal aspects of the query (e.g., whether the query is issued during work hours). There are also features that relate to characteristics of the corpus of the search results set (but not the content of the results). Examples include the number of results for the query and the number of query suggestions, ads, or definitive results.

Search result set feature evaluator 706 is to evaluate at least one feature of a search results set that is produced for the search to predict the variability in user interest based on the feature of the search results set. Thus, other features can be evaluated given knowledge of the set of search results returned for a query. Examples of these features are shown in the lower left-hand quadrant of Table 1. Search result set features may be evaluated using, for instance, the title, the summary, anchor text, and/or the URL for each of the returned search results, or for the top “n” search results. Using this information, search result set features such as query clarity can be evaluated.

Query clarity is a measure of the quality of the search results returned for a query. Query clarity may be calculated for a query without the search engine having previously seen the query. It measures the relative entropy between a query language model and the corresponding collection language model. Query clarity may be calculated using the following equation:

$$Clarity ( q ) = - {\sum }_{Terms t} p ( t \vert q ) * {log}_{2} \frac{p ( t \vert q )}{p ( t )} ,$$

where p(t|q) is the probability of the term occurring given the search result set returned for the query, and p(t) is the probability of the term occurring in the overall search index.

Each search result may also be classified according to which category of multiple categories it fits into (e.g., with categories selected from the ODP). A category classification enables the computation of features related to the entropy of the categories covered by a search result set, the number of categories covered, the number of search results that actually appear in the category set (e.g., in the Open Directory), and so forth. Additional features that may be evaluated include the number of distinct domains that the search results are from, the portion of search results that are from different top level domains, and so forth.

History feature evaluator 708 is to evaluate at least one historical feature derived from one or more previous search submissions of the query to predict the variability in user interest based on the historical feature. Thus, one or more of the features listed in the right hand column of Table 1 can be evaluated if the query has been issued before. Examples of features that involve having seen the query before are shown in the upper right-hand quadrant. These includes the average (Avg) and standard deviation (σ) of the features that can be calculated with one query instance, the number of times the query has been issued, the number of unique users who issue the query, and so forth.

If there is also information about the history of the search results that have previously been returned for the query and/or people's interactions with them, more complex features can be evaluated. Some of these features are listed in the lower right-hand quadrant of Table 1. Given the history of the results displayed for a query, the result entropy can be calculated as a way to capture how often the results change over time. Result entropy may be calculated using the following equation:

$$Result entropy ( q ) = - {\sum }_{URLu} p ( u \vert q ) * {log}_{2} ( p ( u \vert q ) ) ,$$

where p(u|q) is the number of times the URL u was returned in the top “n” results any time the query q was issued. The integer n may be set to any positive number, such as ten.

When histories of user interactions with the search result set are available as implicit indications of relevance, implicit target features such as click entropy and potential for personalization may be calculated. Other features that involve historical knowledge of previous search results include: the average number of results clicked, the average rank of the clicked results, the average amount of time that elapses before a result is clicked following the query, the average number of results an individual clicks for the query, and so forth.

FIGS. 8A and 8B are block diagrams 800A and 800B, respectively, that illustrate an example approach 800 to constructing a potential for personalization curve 406. Potential for personalization curves 406 are described herein above with particular reference to FIG. 4. As noted above, a potential for personalization curve 406 is an example metric for user interest variability. More specifically, a potential for personalization amount 408 indicates how much a personalized search may provide superior results as compared to a general non-personalized search for a given query and/or user.

As illustrated, block diagram 800A includes an interest score calculator 802, a query 110, a user profile 804, a search result 114, and an interest score 306. For an example embodiment, responsive to query 110, interest score calculator 802 is to calculate interest score 306 based on user profile 804 and search result 114. Interest score 306 is for a user 108 associated with user profile 804. Interest score 306 corresponds to the input query 110 and a particular search result 114.

User profile 804 may include recorded behaviors, cached web content, previous web searches, previously clicked results or visited pages, material stored locally, explicit indications of interest, combinations thereof, and so forth. Hence, user profile 804 may be formed from explicit measures, implicit measures, content analysis, behavioral observations, predictions, combinations thereof, and so forth. Interest score 306 may be a discrete number (e.g., 0 or 1) or a continuous number (e.g., from 0.0 to 1.0 if normalized).

As illustrated, block diagram 800B includes a potential for personalization curve constructor 822, user interest score matrix 300, a measure of quality 824, and a constructed potential for personalization curve 406. For an example embodiment, potential for personalization curve constructor 822 is to construct potential for personalization curve 406 based on user interest score matrix 300 and at least one measure of quality 824.

As shown in FIG. 3, multiple interest scores 306 from multiple respective users for multiple search results can be combined for one query into a user interest score matrix 300. Depending on the source(s) of information used to create user interest score matrix 300, potential for personalization curve constructor 822 may therefore be implemented as an explicit potential for personalization curve constructor 604 (of FIG. 6A) or an implicit potential for personalization curve constructor 614 (of FIG. 6B). Alternatively, a potential for personalization curve may be constructed from a combination of implicit and explicit indications that contribute to interest scores 306 of a user interest score matrix 300.

Measure of quality 824 sets forth at least one measure of how well a single search results list meets the user interests of multiple individuals. Examples include, but are not limited to, DCG, Precision at K, combinations thereof, and so forth. Also, a measure of quality may be based on attempting to have each user's most relevant search result ranked in the top “n” results, based on “maximizing” average user interest over the top “n” results, based on attempting to have each user have some interest in one or more of the top “n” results, a combination thereof, and so forth.

Thus, variability in user interest may be determined, for example, by constructing a potential for personalization curve. Respective interest scores 306 are collected (including through calculation) from multiple users for respective search results 114 that are produced for query 110. At least one measure of quality 824 for ranking the search results is selected. Potential for personalization curve 406 is then constructed by potential for personalization curve constructor 822 based on interest scores 306 of a user interest score matrix 300 and at least one measure of quality 824.

FIG. 9 is a block diagram of an example noise compensator 900 for a variability determiner 224 of FIG. 2B. As illustrated, noise compensator 900 includes three compensating units: result set changes component 902, task purpose component 904, and result quality component 906. In an example embodiment, noise compensator 900 is to compensate for noise that permeates implicit user interest variability indications. In other words, the variability indications used by implicit variability measurers 612a and 612b (of FIGS. 6B and 6C) and by variability predictor 702 (of FIG. 7) may be affected by external factors. Noise compensator 900 is to control, at least partially, for noise in the target environment. Each component may be implemented, for example, as a stability feature that is included in the determination of the user interest variability.

Generally, result set changes component 902 is to compensate for noise caused by changes in search result sets that are produced over time for the same query. The noise from result set changes may be modeled responsive to result entropy. Task purpose component 904 is to compensate for noise caused by differences in the particular task a user is attempting to accomplish when issuing a given query. The noise from task purpose differences may be modeled responsive to the average clicks per user. Result quality component 906 is to compensate for noise caused by differences in the quality of the results. The noise from result quality differences may be modeled responsive to the average position of the first click.

More specifically, with regard to compensating for result set changes (e.g., by result set changes component 902), when the potential for personalization curves are constructed implicitly using clicks instead of explicit judgments, the curves are highly correlated with click entropy. There is a greater potential for personalization for queries with high click entropy than there is for queries with low click entropy. However, there several reasons why a query might have high click entropy or a large potential for personalization amount 408 (of FIG. 4), yet not be a good candidate for a personalized search.

For example, queries may have high click entropy because there is a lot of variation in the results displayed for the query. If different search results are presented to one user as compared to what is presented to another, the two users will click on different results even if they would actually consider the same search results to be relevant. It is known that the search results presented for the same query change regularly. Furthermore, some queries experience greater result churn than others, and they therefore have higher click entropy despite possibly not being good candidates for personalization.

Click entropy can be investigated as a function of result entropy. From such an investigation, it becomes apparent that high result entropy is correlated with click entropy. One investigation indicates that queries with result entropy greater than 2 have a 0.55 correlation with click entropy, but queries with result entropy less than 2 have a −0.04 correlation. This trend also holds for the potential for personalization for groups of different sizes. Hence, the effects of result entropy can be at least partially controlled by incorporating personalization into the searches for those queries having a predefined entropy level (e.g., those queries with result entropy lower than two).

With regard to compensating for task purpose differences (e.g., by task purpose component 904), some of the variation in click entropy can result from the nature of the user's task (e.g., navigational or informational). While many queries, such as navigational queries that are directed to a particular web page, are followed by on average one click, others are followed by a number of clicks. For example, a person searching for “cancer” may click on several results while learning about the topic. A result set for a first query in which half the people click on one result and the other half click on another result has the same click entropy as a result set for a second query in which everyone clicks on both results. Although the calculated click entropy is the same, the variation between individuals in what is considered relevant to the queries is clearly very different in the two cases—the first query having a fair amount of user interest variability, and the second query having no user interest variability.

Consequently, it is apparent that click entropy can be correlated with the average number of clicks per user. If the potential for personalization curves for queries with the same click entropy but a different average number of clicks per user are analyzed, queries in which users click on fewer results have a greater potential for personalization than queries in which people click on many results. Thus, the effects of task purpose differences can be at least partially controlled for by factoring into the analysis an average number of clicks per user for the query.

With regard to compensating for result quality differences (e.g., by result quality component 906), there is evidence that variation in click through can be influenced by the quality of the results. For example, it is known that people are more likely to click on the first search result regardless of its relevance, so we would expect search results lists in which the result being sought is not listed first to contain more variation. The average click position is highly correlated with different measures of ambiguity, and this is likely so at least partly because the rank of the first click is correlated with the quality of the search result set. Thus, the effects of result quality differences can be at least partially controlled for by factoring into the analysis the average position of the first click.

FIG. 10 is a flow diagram 1000 that expands FIG. 2A by illustrating example embodiments for enhancing a search experience. As illustrated, flow diagram 1000 includes seven blocks 202, 204, 206a, 206b, 206c, 206d, and 208. The acts of blocks 202, 204, and 208 are described herein above with particular reference to flow diagram 200A of FIG. 2A and flow diagram 500 of FIG. 5. Block 206 of flow diagram 200A entails enhancing a search experience responsive to a determined variability in user interest for a query. Blocks 206a, 206b, 206c, and 206d of flow diagram 1000 provide example embodiments for implementing the act(s) of block 206.

At block 206a, at least one search ranking scheme is selected responsive to the determined variability in user interest. For example, a search ranking scheme that incorporates a personalization component may be selected when the variability in user interest is determined to be relatively high. On the other hand, when the variability in user interest is determined to be relatively low, a search ranking scheme that does not incorporate a personalization component (or that reduces the degree to which the personalization component is incorporated) may be selected.

At block 206b, one or more search ranking parameters are set responsive to the determined variability in user interest. At block 206c, the presentation of search results is adjusted responsive to the determined variability in user interest. At block 206d, user dialog is guided responsive to the determined variability in user interest. For example, if the determined variability in user interest is relatively high, the user may be asked one or more questions to disambiguate the submitted search query. Alternatively, other embodiments may be used to enhance a search experience responsive to user interest variability.

FIG. 11 is a block diagram 1100 that illustrates an example embodiment for a search experience enhancer 226, which is shown generally in FIG. 2B. As shown, block diagram 1100 includes a query 110, a search interface 222, a variability determiner 224, and search experience enhancer 226*. Search interface 222 is described herein above with particular reference to FIG. 2B. Variability determiner 224 is described herein above with particular reference to FIGS. 2B, 6A-6C, and 7.

In an example embodiment, search experience enhancer 226* is to analyze a determined user interest variability amount at 1102. If the user interest variability amount is relatively low, then a first search ranking scheme 1104a is incorporated into the search. If the user interest variability amount is relatively high, then a second search ranking scheme 1104b is incorporated into the search. First search ranking scheme 1104a may be, for example, a non-personalized search ranking scheme. Second search ranking scheme 1104b may be, for example, a personalized search ranking scheme.

An example of a user interest variability amount is a potential for personalization amount 408 (of FIG. 4). This user interest variability amount may be considered relatively high or relatively low in comparison to a predefined amount. Alternatively, first search ranking scheme 1104a and second search ranking scheme 1104b may both be incorporated into a search in combination. For example, a linear combination mechanism may combine two or more search ranking schemes by setting a degree to which each is incorporated when preparing a set of search results for query 110. With an example linear combination mechanism, a prediction of the user interest variability amount may be used to set a variable α. The combined search ranking scheme may then be ascertained as function, such as with the following function: α first-scheme+(1−α) second-scheme.

FIG. 12 is a block diagram 1200 illustrating an example learning machine embodiment for determining user interest variability. As illustrated, block diagram 1200 includes user interest variability learning machine 1202, a learning input 1204, training information 1206, features 1208, and user interest variability 230. Example features 1208 include query features 1208Q, search result features 1208R, and historical features 1208H. An example of user interest variability 230 is potential for personalization amount 408.

In an example embodiment, training information 1206 is applied to learning input 1204 of user interest variability learning machine 1202 to learn its algorithm. Example learning algorithms include, by way of example but not limitation, support vector machines (SVMs), non-linear classification schemes, including methods referred to as neural networks, genetic algorithms, K-nearest neighbor algorithms, regression models, decision trees, a combination or kernelized version thereof, and so forth. In operation, one or more features 1208 are input to user interest variability learning machine 1202. After analysis in accordance with its learning algorithm, user interest variability learning machine 1202 outputs user interest variability 230. Although not explicitly shown, stability feature(s) (which are described above with reference to FIG. 9) may also be input to user interest variability learning machine 1202.

Query feature(s) 1208Q may be directly derived from the query. Search result feature(s) 1208R may be derived from current search results. Historical feature(s) 1208H may be derived from previous instances of submitted queries and/or returned search results. Additional examples of such query features 1208Q, search result features 1208R, and historical features 1208H are provided herein above, e.g., at Table 1.

With reference to system 200B (of FIG. 2B), user interest variability learning machine 1202 may form at least part of variability determiner 224. In alternative embodiments, user interest variability learning machine 1202 may comprise part of an overall search system learning machine that produces search results 114 (of FIGS. 1 and 2B).

### 4: Example Device Implementations for Enhancing Searches Responsive to User Interest Variability

FIG. 13 is a block diagram 1300 illustrating example devices 1302 that may be used to implement embodiments for enhancing searches responsive to user interest variability. As illustrated, block diagram 1300 includes two devices 1302a and 1302b, person-device interface equipment 1312, and one or more network(s) 112. As explicitly shown with device 1302a, each device 1302 may include one or more input/output interfaces 1304, at least one processor 1306, and one or more media 1308. Media 1308 may include processor-executable instructions 1310.

For example embodiments, device 1302 may represent any processing-capable device. Example devices 1302 include personal or server computers, hand-held electronics, entertainment appliances, network components, some combination thereof, and so forth. Device 1302a and device 1302b may communicate over network(s) 112. Network(s) 112 may be, by way of example but not limitation, an internet, an intranet, an Ethernet, a public network, a private network, a cable network, a digital subscriber line (DSL) network, a telephone network, a wireless network, some combination thereof, and so forth. Person-device interface equipment 1312 may be a keyboard/keypad, a touch screen, a remote, a mouse or other graphical pointing device, a screen, a speaker, and so forth.

I/O interfaces 1304 may include (i) a network interface for monitoring and/or communicating across network 112, (ii) a display device interface for displaying information on a display screen, (iii) one or more person-device interfaces, and so forth. Examples of (i) network interfaces include a network card, a modem, one or more ports, a network communications stack, a radio, and so forth. Examples of (ii) display device interfaces include a graphics driver, a graphics card, a hardware or software driver for a screen or monitor, and so forth. Examples of (iii) person-device interfaces include those that communicate by wire or wirelessly to person-device interface equipment 1312.

Processor 1306 may be implemented using any applicable processing-capable technology, and one may be realized as a general-purpose or a special-purpose processor. Examples include a central processing unit (CPU), a microprocessor, a controller, a graphics processing unit (GPU), a derivative or combination thereof, and so forth. Media 1308 may be any available media that is included as part of and/or is accessible by device 1302. It includes volatile and non-volatile media, removable and non-removable media, storage and transmission media (e.g., wireless or wired communication channels), hard-coded logic media, combinations thereof, and so forth. Media 1308 is tangible media when it is embodied as a manufacture and/or as a composition of matter.

Generally, processor 1306 is capable of executing, performing, and/or otherwise effectuating processor-executable instructions, such as processor-executable instructions 1310. Media 1308 is comprised of one or more processor-accessible media. In other words, media 1308 may include processor-executable instructions 1310 that are executable by processor 1306 to effectuate the performance of functions by device 1302. Processor-executable instructions 1310 may be embodied as software, firmware, hardware, fixed logic circuitry, some combination thereof, and so forth.

Thus, realizations for enhancing searches responsive to user interest variability may be described in the general context of processor-executable instructions. Processor-executable instructions may include routines, programs, applications, coding, modules, protocols, objects, components, metadata and definitions thereof, data structures, application programming interfaces (APIs), etc. that perform and/or enable particular tasks and/or implement particular abstract data types. Processor-executable instructions may be located in separate storage media, executed by different processors, and/or propagated over or extant on various transmission media.

As specifically illustrated, media 1308 comprises at least processor-executable instructions 1310. Processor-executable instructions 1310 may comprise, for example, search logic 102 (of FIG. 1), any of the components of system 200B (of FIG. 2B), and/or user interest variability learning machine 1202 (of FIG. 12). Generally, processor-executable instructions 1310, when executed by processor 1306, enable device 1302 to perform the various functions described herein. Such functions include, by way of example, those that are illustrated in the various flow diagrams and those pertaining to features illustrated in the block diagrams, as well as combinations thereof, and so forth.

The devices, acts, features, functions, methods, modules, data structures, techniques, components, etc. of FIGS. 1-13 are illustrated in diagrams that are divided into multiple blocks and other elements. However, the order, interconnections, interrelationships, layout, etc. in which FIGS. 1-13 are described and/or shown are not intended to be construed as a limitation, and any number of the blocks and/or other elements can be modified, combined, rearranged, augmented, omitted, etc. in any manner to implement one or more systems, methods, devices, media, apparatuses, arrangements, etc. for enhancing searches responsive to user interest variability.

Although systems, methods, devices, media, apparatuses, arrangements, and other example embodiments have been described in language specific to structural, logical, algorithmic, and/or functional features, it is to be understood that the invention defined in the appended claims is not necessarily limited to the specific features or acts described above. Rather, the specific features and acts described above are disclosed as example forms of implementing the claimed invention.

What is claimed is:

1. A device-implemented method to enhance searching, the method comprising acts of:
accepting a query from a user as input for a search;
determining a variability in user interest for the query, the variability in user interest reflecting an amount that interests of different users for different search results vary for the query;
enhancing a search experience for the user by incorporating a degree of personalization into the search responsive to the variability in user interest; and
presenting a set of search results in accordance with the enhanced search experience.

2. The method as recited in claim 1, wherein the act of enhancing comprises:
increasing the degree of personalization that is incorporated into the search responsive to increases in the variability in user interest.

3. The method as recited in claim 2, wherein the act of determining comprises:
determining a potential for personalization amount that reflects the amount that interests of different users for different search results vary for the query.

4. The method as recited in claim 3, wherein the act of determining further comprises:
building at least one user interest score matrix based on multiple interest scores; and
determining the potential for personalization amount at one or more group sizes to produce at least part of a potential for personalization curve responsive to the at least one user interest score matrix.

5. A system to enhance searching, the system comprising:
a search interface to accept a query from a user as input for a search;
a variability determiner to determine a variability in user interest for the query, the variability in user interest reflecting an amount that interests of different users for different search results vary for the query; and
a search experience enhancer to enhance a search experience for the user responsive to the variability in user interest.

6. The system as recited in claim 5, wherein the variability determiner comprises:
an implicit variability measurer to measure the variability in user interest with one or more implicit indications, the implicit variability measurer including an implicit potential for personalization curve constructor or a click entropy calculator; wherein the implicit potential for personalization curve constructor is to construct a potential for personalization curve that represents the variability in user interest at different group sizes, and the click entropy calculator is to calculate a click entropy for the query based on a probability that individual search results are clicked for the query.

7. The system as recited in claim 5, wherein the variability determiner comprises:
an implicit variability measurer to measure the variability in user interest with one or more implicit indications, the implicit variability measurer including a behavior-based variability measurer; wherein the behavior-based variability measurer is to measure the variability in user interest based on at least one observable user interaction behavior with a search results listing that is presented for the query.

8. The system as recited in claim 5, wherein the variability determiner comprises:
an implicit variability measurer to measure the variability in user interest with one or more implicit indications, the implicit variability measurer including a content-based variability measurer; wherein the content-based variability measurer is to measure the variability in user interest based on content by comparing a user profile to search results produced for the query.

9. The system as recited in claim 5, wherein the variability determiner comprises:
a variability predictor that includes a query feature evaluator to evaluate at least one feature of the query, wherein the query feature evaluator is to predict the variability in user interest based on the at least one feature of the query.

10. The system as recited in claim 5, wherein the variability determiner comprises:
a variability predictor that includes a search result set feature evaluator to evaluate at least one feature of a search results set produced for the search, wherein the search result set feature evaluator is to predict the variability in user interest based on the at least one feature of the search results set.

11. The system as recited in claim 5, wherein the variability determiner comprises:
a variability predictor that includes a history feature evaluator to evaluate at least one historical feature derived from one or more previous search submissions of the query, wherein the history feature evaluator is to predict the variability in user interest based on the at least one historical feature.

12. The system as recited in claim 5, wherein the search experience enhancer comprises a first search ranking scheme and a second search ranking scheme; and wherein the search experience enhancer is to incorporate the first search ranking scheme and the second search ranking scheme into the search responsive to the variability in user interest when the system is ranking a set of search results produced for the search.

13. The system as recited in claim 12, wherein the first search ranking scheme comprises a personalized search ranking scheme, and the second search ranking scheme comprises a non-personalized search ranking scheme; and wherein the search experience enhancer is to combine the first search ranking scheme and the second search ranking scheme in accordance with a linear combination mechanism responsive to the variability in user interest.

14. The system as recited in claim 5, wherein the variability determiner comprises:
a noise compensator to compensate for noise that permeates implicit user interest variability indications; wherein the noise compensator is to compensate for result set changes for the query over time, for task purpose differences among queries, or for result quality differences.

15. A device-implemented method to enhance searching, the method comprising acts of:
accepting a query from a user as input for a search;
determining a variability in user interest for the query, the variability in user interest reflecting an amount that interests of different users for different search results vary for the query; and
enhancing a search experience for the user responsive to the variability in user interest.

16. The method as recited in claim 15, wherein the act of determining comprises:
explicitly measuring the variability in user interest for the query;
implicitly measuring the variability in user interest for the query; or
predicting the variability in user interest for the query.

17. The method as recited in claim 15, wherein the act of enhancing comprises:
selecting at least one search ranking scheme for performing the search responsive to the variability in user interest;
setting one or more search ranking parameters for search results of the search responsive to the variability in user interest;
adjusting a search results presentation responsive to the variability in user interest; or
presenting a user dialog to disambiguate the query responsive to the variability in user interest.

18. The method as recited in claim 15, wherein the act of enhancing comprises:
increasing a degree of personalization incorporated into the search as the variability in user interest increases.

19. The method as recited in claim 15, wherein the act of determining comprises constructing a potential for personalization curve by:
collecting respective interest scores from multiple users for respective search results for the query;
selecting at least one measure of quality for ranking search results; and
constructing the potential for personalization curve based on the interest scores and the at least one measure of quality.

20. The method as recited in claim 19, wherein a gap between an optimal flat potential for personalization curve and the constructed potential for personalization curve defines a potential for personalization amount, the potential for personalization amount reflecting an amount that the search for the query may be enhanced by incorporating a degree of personalization.
